(19) United States
(12) Patent Application Publication
(10) Pub. No.: US 2020/0396571 A1
(43) Pub. Date: Dec. 17, 2020

(54) METHOD FOR SENDING AND RECEIVING SMS-RELATED SIGNALS IN WIRELESS COMMUNICATION SYSTEM AND APPARATUS THEREFOR

(71) Applicant: LG ELECTRONICS INC., Seoul (KR)

(72) Inventor: Laeyoung Kim, Seoul (KR)

(21) Appl. No.: 16/977,723

(22) PCT Filed: Mar. 8, 2019
(86) PCT No.: PCT/KR2019/002744

§ 371 Date: Sep. 2, 2020

(30) Foreign Application Priority Data
Mar. 8, 2018 (KR) 10-2018-0027650

(51) Int. Cl. H04W 4/14; H04W 48/16; H04W 40/24

(52) U.S. Cl. CPC H04W 4/14; H04W 40/246; H04W 48/16

(57) ABSTRACT

An embodiment of the present invention relates to a method for sending and receiving short message service (SMS)-related signals of unified data management (UDM) in a wireless communication system, the method comprising: a step in which the UDM receives, from an SMS gateway MSC (SMS-GMSC), a message requesting routing information on an SMS to a UE; a step in which the UDM confirms whether a public land mobile network (PLMN) of an SMS function (SMSF) is same as the PLMN of an SMS serving node; a step in which the UDM sends, to the SMSF, a reachability confirmation request message about an SMS serving node of which the PLMN is not same as the PLMN of the SMSF; a step in which the UDM receives, from the SMSF, a response to the reachability confirmation request message; a step in which the UDM sends the routing information to the SMSF on the basis of a result of the confirmation and the response to the reachability confirmation request message; and a step in which the UDM sends, to the SMS-GMSC, a response message to the message requesting the routing information.

### TECHNICAL FIELD

The following description relates to a wireless communication system and, more particularly, to a method and apparatus for transmitting and receiving a short message service (SMS)-related signal when an SMS serving node other than an SMS function (SMSF) is not reachable to the SMSF.

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.) among them. For example, multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi-carrier frequency division multiple access (MC-FDMA) system.

### DETAILED DESCRIPTION OF THE DISCLOSURE

### Technical Problems

An object of the present disclosure is to provide a processing scheme of an SMS when an SMS serving node other than an SMSF is not reachable to the SMSF.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solutions

According to an aspect of the present disclosure, provided herein is a method of transmitting and receiving a short message service (SMS)-related signal of a unified data management (UDM) in a wireless communication system, including receiving, by the UDM, a message for making a request to a user equipment (UE) for routing information about the SMS from an SMS-gateway mobile switching center (GMSC); checking whether a public land mobile network (PLMN) of an SMS function (SMSF) is identical to a PLMN of an SMS serving node; transmitting, by the UDM, a reachability check request message for an SMS serving node, a PLMN of which is not identical to the PLMN of the SMSF, to the SMSF; receiving, by the UDM, a response to the reachability check request message from the SMSF; transmitting, by the UDM, routing information to the SMSF based on the check result and the response to the reachability check request message; and transmitting, by the UDM, a response message for the message for requesting the routing information to the SMS-GMSC.

In another aspect of the present disclosure, provided herein is a unified data management (UDM) device for transmitting and receiving a short message service (SMS)-related signal in a wireless communication system, including a memory; and at least one processor coupled to the memory, wherein the at least one processor is configured to receive a message for making a request to a user equipment (UE) for routing information about the SMS from an SMS-gateway mobile switching center (GMSC), check whether a public land mobile network (PLMN) of an SMS function (SMSF) is identical to a PLMN of an SMS serving node, transmit a reachability check request message for an SMS serving node, a PLMN of which is not identical to the PLMN of the SMSF, to the SMSF, receive a response to the reachability check request message from the SMSF, transmit routing information to the SMSF based on the check result and the response to the reachability check request message, and transmit a response message for the message for requesting the routing information to the SMS-GMSC.

The response message for the message for requesting the routing information may include information about an SMS serving node which is not reachable to the SMSF.

The SMS serving node may not be reachable to the SMSF in absence of an interface between the SMS serving node and the SMSF.

The routing information may include information about an SMS serving node which is reachable to the SMSF.

An SMS serving node which is reachable to the SMSF attempts to transmit the SMS upon transmission failure of the SMS by the SMSF.

The SMS serving node may be one of a mobile switching center (MSC), a mobility management entity (MME), and an IP short-messaging gateway (IP-SM-GW).

The information about the SMS serving node may be one of information about an address of the SMS serving node or (? and) information about a PLMN to which the SMS serving node belongs.

### Advantageous Effects

According to the present disclosure, a clear guideline about how to process an SMS when an SMS serving node other than an SMSF is not reachable to the SMSF is provided.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

The accompanying drawings, which are included to provide a further understanding of the present disclosure and are incorporated in and constitute a part of this application, illustrate embodiments of the present disclosure and together with the description serve to explain the principle of the disclosure.

FIG. 1 is a schematic diagram illustrating the structure of an evolved packet system (EPS) including an evolved packet core (EPC).

FIG. 2 is a diagram illustrating the general architectures of an E-UTRAN and an EPC.

FIG. 3 is a diagram illustrating the structure of a radio interface protocol in a control plane.

FIG. 4 is a diagram illustrating the structure of a radio interface protocol in a user plane.

FIG. 5 is a flowchart illustrating a random access procedure.

FIG. 6 is a diagram illustrating a connection process in a radio resource control (RRC) layer.

FIG. 7 is a diagram illustrating a 5th generation (5G) system.

FIG. 8 illustrates a non-roaming architecture supporting non-3GPP access

FIG. 9 illustrates an interworking architecture between a 5G system and an EPS when a UE does not roam.

FIG. 10 illustrates a non-roaming system architecture for an SMS over NAS.

FIG. 11 illustrates an SMS transmission architecture related to an MME.

FIGS. 12 and 13 illustrate network situations to which an embodiment of the present disclosure is applicable.

FIGS. 14 to 19 are diagrams illustrating each embodiment of the present disclosure.

FIG. 20 is a diagram illustrating a configuration of a node device according an embodiment of the present disclosure.

### BEST MODE FOR CARRYING OUT THE DISCLOSURE

The embodiments below are combinations of components and features of the present disclosure in a prescribed form. Each component or feature may be considered as selective unless explicitly mentioned as otherwise. Each component or feature may be executed in a form that is not combined with other components and features. Further, some components and/or features may be combined to configure an embodiment of the present disclosure. The order of operations described in the embodiments of the present disclosure may be changed. Some components or features of an embodiment may be included in another embodiment or may be substituted with a corresponding component or feature of the present disclosure.

Specific terms used in the description below are provided to help an understanding of the present disclosure, and the use of such specific terms may be changed to another form within the scope of the technical concept of the present disclosure.

In some cases, in order to avoid obscurity of the concept of the present disclosure, a known structure and apparatus may be omitted, or a block diagram centering on core functions of each structure or apparatus may be used. Moreover, the same reference numerals are used for the same components throughout the present specification.

The embodiments of the present disclosure may be supported by standard documents disclosed with respect to at least one of IEEE (Institute of Electrical and Electronics Engineers) 802 group system, 3GPP system, 3GPP LTE and LTE-A system and 3GPP2 system. Namely, the steps or portions having not been described in order to clarify the technical concept of the present disclosure in the embodiments of the present disclosure may be supported by the above documents. Furthermore, all terms disclosed in the present document may be described according to the above standard documents.

The technology below may be used for various wireless communication systems. For clarity, the description below centers on 3GPP LTE and 3GPP LTE-A, by which the technical idea of the present disclosure is non-limited.

Terms used in the present document are defined as follows.
UMTS (Universal Mobile Telecommunications System): a GSM (Global System for Mobile Communication) based third generation mobile communication technology developed by the 3GPP.
EPS (Evolved Packet System): a network system that includes an EPC (Evolved Packet Core) which is an IP (Internet Protocol) based packet switched core network and an access network such as LTE and UTRAN. This system is the network of an evolved version of the UMTS.
NodeB: a base station of GERAN/UTRAN. This base station is installed outdoor and its coverage has a scale of a macro cell.
eNodeB: a base station of LTE. This base station is installed outdoor and its coverage has a scale of a macro cell.
UE (User Equipment): the UE may be referred to as terminal, ME (Mobile Equipment), MS (Mobile Station), etc. Also, the UE may be a portable device such as a notebook computer, a cellular phone, a PDA (Personal Digital Assistant), a smart phone, and a multimedia device. Alternatively, the UE may be a non-portable device such as a PC (Personal Computer) and a vehicle mounted device. The term “UE”, as used in relation to MTC, can refer to an MTC device.
HNB (Home NodeB): a base station of UMTS network. This base station is installed indoor and its coverage has a scale of a micro cell.
HeNB (Home eNodeB): a base station of an EPS network. This base station is installed indoor and its coverage has a scale of a micro cell.
MME (Mobility Management Entity): a network node of an EPS network, which performs mobility management (MM) and session management (SM).
PDN-GW (Packet Data Network-Gateway)/PGW: a network node of an EPS network, which performs UE IP address allocation, packet screening and filtering, charging data collection, etc.
SGW (Serving Gateway): a network node of an EPS network, which performs mobility anchor, packet routing, idle-mode packet buffering, and triggering of an MME's UE paging.
NAS (Non-Access Stratum): an upper stratum of a control plane between a UE and an MME. This is a functional layer for transmitting and receiving a signaling and traffic message between a UE and a core network in an LTE/UMTS protocol stack, and supports mobility of a UE, and supports a session management procedure of establishing and maintaining IP connection between a UE and a PDN GW.
PDN (Packet Data Network): a network in which a server supporting a specific service (e.g., a Multimedia Messaging Service (MMS) server, a Wireless Application Protocol (WAP) server, etc.) is located.
PDN connection: a logical connection between a UE and a PDN, represented as one IP address (one IPv4 address and/or one IPv6 prefix).
RAN (Radio Access Network): a unit including a Node B, an eNodeB, and a Radio Network Controller (RNC) for controlling the Node B and the eNodeB in a 3GPP network, which is present between UEs and provides a connection to a core network.
HLR (Home Location Register)/HSS (Home Subscriber Server): a database having subscriber information in a 3GPP network. The HSS can perform functions such as configuration storage, identity management, and user state storage.
PLMN (Public Land Mobile Network): a network configured for the purpose of providing mobile communication services to individuals. This network can be configured per operator.
Proximity Services (or ProSe Service or Proximity-based Service): a service that enables discovery between physically proximate devices, and mutual direct communication/communication through a base station/communication through the third party. At this time, user plane data is exchanged through a direct data path without passing through a 3GPP core network (e.g., EPC).

EPC (Evolved Packet Core)

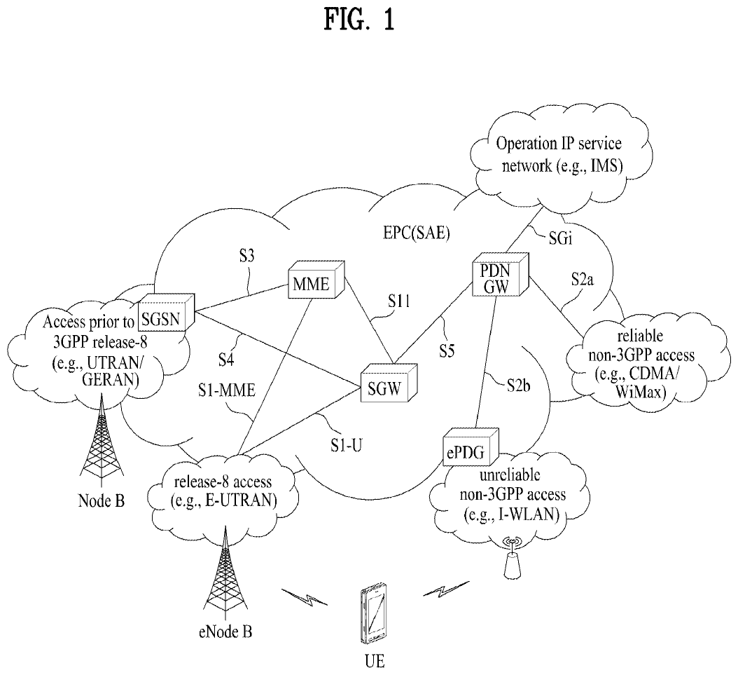

FIG. 1 is a schematic diagram showing the structure of an evolved packet system (EPS) including an evolved packet core (EPC).

The EPC is a core element of system architecture evolution (SAE) for improving performance of 3GPP technology. SAE corresponds to a research project for determining a network structure supporting mobility between various types of networks. For example, SAE aims to provide an optimized packet-based system for supporting various radio access technologies and providing an enhanced data transmission capability.

Specifically, the EPC is a core network of an IP mobile communication system for 3GPP LTE and can support real-time and non-real-time packet-based services. In conventional mobile communication systems (i.e. second-generation or third-generation mobile communication systems), functions of a core network are implemented through a circuit-switched (CS) sub-domain for voice and a packet-switched (PS) sub-domain for data. However, in a 3GPP LTE system which is evolved from the third generation communication system, CS and PS sub-domains are unified into one IP domain. That is, in 3GPP LTE, connection of terminals having IP capability can be established through an IP-based business station (e.g., an eNodeB (evolved Node B)), EPC, and an application domain (e.g., IMS). That is, the EPC is an essential structure for end-to-end IP services.

The EPC may include various components. FIG. 1 shows some of the components, namely, a serving gateway (SGW), a packet data network gateway (PDN GW), a mobility management entity (MME), a serving GPRS (general packet radio service) supporting node (SGSN) and an enhanced packet data gateway (ePDG).

SGW (or S-GW) operates as a boundary point between a radio access network (RAN) and a core network and maintains a data path between an eNodeB and the PDN GW. When. When a terminal moves over an area served by an eNodeB, the SGW functions as a local mobility anchor point. That is, packets. That is, packets may be routed through the SGW for mobility in an evolved UMTS terrestrial radio access network (E-UTRAN) defined after 3GPP release-8. In addition, the SGW may serve as an anchor point for mobility of another 3GPP network (a RAN defined before 3GPP release-8, e.g., UTRAN or GERAN (global system for mobile communication (GSM)/enhanced data rates for global evolution (EDGE) radio access network).

The PDN GW (or P-GW) corresponds to a termination point of a data interface for a packet data network. The PDN GW may support policy enforcement features, packet filtering and charging support. In addition, the PDN GW may serve as an anchor point for mobility management with a 3GPP network and a non-3GPP network (e.g., an unreliable network such as an interworking wireless local area network (I-WLAN) and a reliable network such as a code division multiple access (CDMA) or WiMax network).

Although the SGW and the PDN GW are configured as separate gateways in the example of the network structure of FIG. 1, the two gateways may be implemented according to a single gateway configuration option.

The MME performs signaling and control functions for supporting access of a UE for network connection, network resource allocation, tracking, paging, roaming and handover. The MME controls control plane functions associated with subscriber and session management. The MME manages numerous eNodeBs and signaling for selection of a conventional gateway for handover to other 2G/3G networks. In addition, the MME performs security procedures, terminal-to-network session handling, idle terminal location management, etc.

The SGSN handles all packet data such as mobility management and authentication of a user for other 3GPP networks (e.g., a GPRS network).

The ePDG serves as a security node for a non-3GPP network (e.g., an I-WLAN, a Wi-Fi hotspot, etc.).

As described above with reference to FIG. 1, a terminal having IP capabilities may access an IP service network (e.g., an IMS) provided by an operator via various elements in the EPC not only based on 3GPP access but also based on non-3GPP access.

Additionally, FIG. 1 shows various reference points (e.g. S1-U, S1-MME, etc.). In 3GPP, a conceptual link connecting two functions of different functional entities of an E-UTRAN and an EPC is defined as a reference point. Table 1 is a list of the reference points shown in FIG. 1. Various reference points may be present in addition to the reference points in Table 1 according to network structures.

TABLE 1

| Reference | |
|---|---|
| point | Description |
| S1-MME | Reference point for the control plane protocol between E-UTRAN and MME |
| S1-U | Reference point between E-UTRAN and Serving GW for the per bearer user plane |
| | tunneling and inter eNodeB path switching during handover |
| S3 | It enables user and bearer information exchange for inter 3GPP access network |
| | mobility in idle and/or active state. This reference point can be used intra-PLMN |
| | or inter-PLMN (e.g. in the case of Inter-PLMN HO). |
| S4 | It provides related control and mobility support between GPRS Core and the 3GPP |
| | Anchor function of Serving GW. In addition, if Direct Tunnel is not established, it |
| | provides the user plane tunneling. |
| S5 | It provides user plane tunneling and tunnel management between Serving GW and |
| | PDN GW. It is used for Serving GW relocation due to UE mobility and if the |
| | Serving GW needs to connect to a non-collocated PDN GW for the required PDN |
| | connectivity. |
| S11 | Reference point between an MME and an SGW |
| SGi | It is the reference point between the PDN GW and the packet data network. Packet |
| | data network may be an operator external public or private packet data network or |
| | an intra operator packet data network, e.g. for provision of IMS services. This |
| | reference point corresponds to Gi for 3GPP accesses. |

Among the reference points shown in FIG. 1, S2a and S2b correspond to non-3GPP interfaces. S2a is a reference point which provides reliable non-3GPP access and related control and mobility support between PDN GWs to a user plane. S2b is a reference point which provides related control and mobility support between the ePDG and the PDN GW to the user plane.

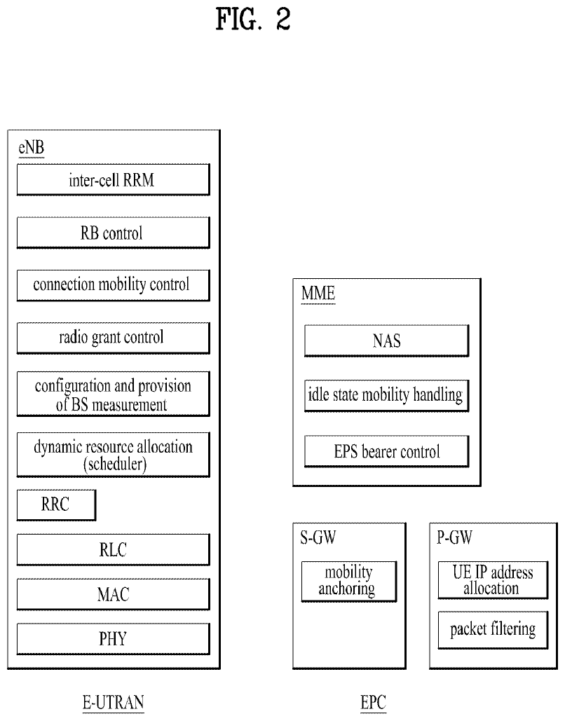

FIG. 2 is a diagram exemplarily illustrating architectures of a typical E-UTRAN and EPC.

As shown in the figure, while radio resource control (RRC) connection is activated, an eNodeB may perform routing to a gateway, scheduling transmission of a paging message, scheduling and transmission of a broadcast channel (BCH), dynamic allocation of resources to a UE on uplink and downlink, configuration and provision of eNodeB measurement, radio bearer control, radio admission control, and connection mobility control. In the EPC, paging generation, LTE_IDLE state management, ciphering of the user plane, SAE bearer control, and ciphering and integrity protection of NAS signaling.

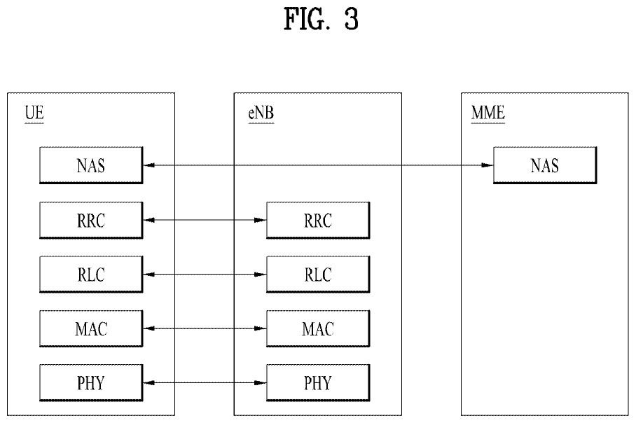

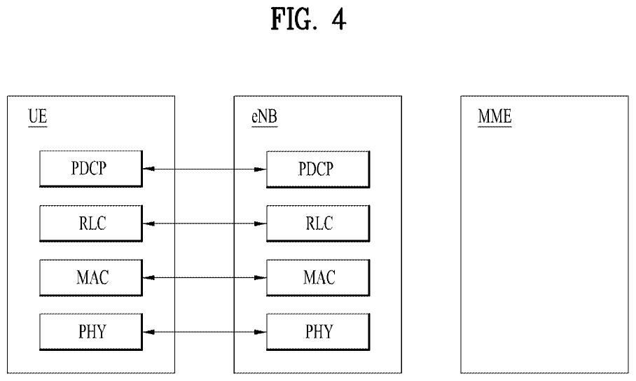

FIG. 3 is a diagram exemplarily illustrating the structure of a radio interface protocol in a control plane between a UE and a base station, and FIG. 4 is a diagram exemplarily illustrating the structure of a radio interface protocol in a user plane between the UE and the base station.

The radio interface protocol is based on the 3GPP wireless access network standard. The radio interface protocol horizontally includes a physical layer, a data link layer, and a networking layer. The radio interface protocol is divided into a user plane for transmission of data information and a control plane for delivering control signaling which are arranged vertically.

The protocol layers may be classified into a first layer (L1), a second layer (L2), and a third layer (L3) based on the three sublayers of the open system interconnection (OSI) model that is well known in the communication system.

Hereinafter, description will be given of a radio protocol in the control plane shown in FIG. 3 and a radio protocol in the user plane shown in FIG. 4.

The physical layer, which is the first layer, provides an information transfer service using a physical channel. The physical channel layer is connected to a medium access control (MAC) layer, which is a higher layer of the physical layer, through a transport channel. Data is transferred between the physical layer and the MAC layer through the transport channel. Transfer of data between different physical layers, i.e., a physical layer of a transmitter and a physical layer of a receiver is performed through the physical channel.

The physical channel consists of a plurality of subframes in the time domain and a plurality of subcarriers in the frequency domain. One subframe consists of a plurality of symbols in the time domain and a plurality of subcarriers. One subframe consists of a plurality of resource blocks. One resource block consists of a plurality of symbols and a plurality of subcarriers. A Transmission Time Interval (TTI), a unit time for data transmission, is 1 ms, which corresponds to one subframe.

According to 3GPP LTE, the physical channels present in the physical layers of the transmitter and the receiver may be divided into data channels corresponding to Physical Downlink Shared Channel (PDSCH) and Physical Uplink Shared Channel (PUSCH) and control channels corresponding to Physical Downlink Control Channel (PDCCH), Physical Control Format Indicator Channel (PCFICH), Physical Hybrid-ARQ Indicator Channel (PHICH) and Physical Uplink Control Channel (PUCCH).

The second layer includes various layers.

First, the MAC layer in the second layer serves to map various logical channels to various transport channels and also serves to map various logical channels to one transport channel. The MAC layer is connected with an RLC layer, which is a higher layer, through a logical channel. The logical channel is broadly divided into a control channel for transmission of information of the control plane and a traffic channel for transmission of information of the user plane according to the types of transmitted information.

The radio link control (RLC) layer in the second layer serves to segment and concatenate data received from a higher layer to adjust the size of data such that the size is suitable for a lower layer to transmit the data in a radio interval.

The Packet Data Convergence Protocol (PDCP) layer in the second layer performs a header compression function of reducing the size of an IP packet header which has a relatively large size and contains unnecessary control information, in order to efficiently transmit an IP packet such as an IPv4 or IPv6 packet in a radio interval having a narrow bandwidth. In addition, in LTE, the PDCP layer also performs a security function, which consists of ciphering for preventing a third party from monitoring data and integrity protection for preventing data manipulation by a third party.

The Radio Resource Control (RRC) layer, which is located at the uppermost part of the third layer, is defined only in the control plane, and serves to configure radio bearers (RBs) and control a logical channel, a transport channel, and a physical channel in relation to reconfiguration and release operations. The RB represents a service provided by the second layer to ensure data transfer between a UE and the E-UTRAN.

If an RRC connection is established between the RRC layer of the UE and the RRC layer of a wireless network, the UE is in the RRC Connected mode. Otherwise, the UE is in the RRC Idle mode.

Hereinafter, description will be given of the RRC state of the UE and an RRC connection method. The RRC state refers to a state in which the RRC of the UE is or is not logically connected with the RRC of the E-UTRAN. The RRC state of the UE having logical connection with the RRC of the E-UTRAN is referred to as an RRC_CONNECTED state. The RRC state of the UE which does not have logical connection with the RRC of the E-UTRAN is referred to as an RRC_IDLE state. A UE in the RRC_CONNECTED state has RRC connection, and thus the E-UTRAN may recognize presence of the UE in a cell unit. Accordingly, the UE may be efficiently controlled. On the other hand, the E-UTRAN cannot recognize presence of a UE which is in the RRC_IDLE state. The UE in the RRC_IDLE state is managed by a core network in a tracking area (TA) which is an area unit larger than the cell. That is, for the UE in the RRC_IDLE state, only presence or absence of the UE is recognized in an area unit larger than the cell. In order for the UE in the RRC_IDLE state to be provided with a usual mobile communication service such as a voice service and a data service, the UE should transition to the RRC_CONNECTED state. A TA is distinguished from another TA by a tracking area identity (TAI) thereof. A UE may configure the TAI through a tracking area code (TAC), which is information broadcast from a cell.

When the user initially turns on the UE, the UE searches for a proper cell first. Then, the UE establishes RRC connection in the cell and registers information thereabout in the core network. Thereafter, the UE stays in the RRC_IDLE state. When necessary, the UE staying in the RRC_IDLE state selects a cell (again) and checks system information or paging information. This operation is called camping on a cell. Only when the UE staying in the RRC_IDLE state needs to establish RRC connection, does the UE establish RRC connection with the RRC layer of the E-UTRAN through the RRC connection procedure and transition to the RRC_CONNECTED state. The UE staying in the RRC_IDLE state needs to establish RRC connection in many cases. For example, the cases may include an attempt of a user to make a phone call, an attempt to transmit data, or transmission of a response message after reception of a paging message from the E-UTRAN.

The non-access stratum (NAS) layer positioned over the RRC layer performs functions such as session management and mobility management.

Hereinafter, the NAS layer shown in FIG. 3 will be described in detail.

The eSM (evolved Session Management) belonging to the NAS layer performs functions such as default bearer management and dedicated bearer management to control a UE to use a PS service from a network. The UE is assigned a default bearer resource by a specific packet data network (PDN) when the UE initially accesses the PDN. In this case, the network allocates an available IP to the UE to allow the UE to use a data service. The network also allocates QoS of a default bearer to the UE. LTE supports two kinds of bearers. One bearer is a bearer having characteristics of guaranteed bit rate (GBR) QoS for guaranteeing a specific bandwidth for transmission and reception of data, and the other bearer is a non-GBR bearer which has characteristics of best effort QoS without guaranteeing a bandwidth. The default bearer is assigned to a non-GBR bearer. The dedicated bearer may be assigned a bearer having QoS characteristics of GBR or non-GBR.

A bearer allocated to the UE by the network is referred to as an evolved packet service (EPS) bearer. When the EPS bearer is allocated to the UE, the network assigns one ID. This ID is called an EPS bearer ID. One EPS bearer has QoS characteristics of a maximum bit rate (MBR) and/or a guaranteed bit rate (GBR).

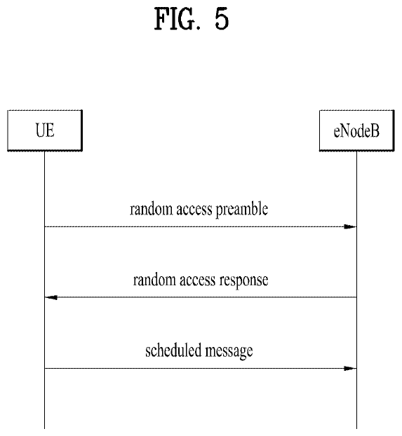

FIG. 5 is a flowchart illustrating a random access procedure in 3GPP LTE.

The random access procedure is used for a UE to obtain UL synchronization with an eNB or to be assigned a UL radio resource.

The UE receives a root index and a physical random access channel (PRACH) configuration index from an eNodeB. Each cell has 64 candidate random access preambles defined by a Zadoff-Chu (ZC) sequence. The root index is a logical index used for the UE to generate 64 candidate random access preambles.

Transmission of a random access preamble is limited to a specific time and frequency resources for each cell. The PRACH configuration index indicates a specific subframe and preamble format in which transmission of the random access preamble is possible.

The UE transmits a randomly selected random access preamble to the eNodeB. The UE selects a random access preamble from among 64 candidate random access preambles and the UE selects a subframe corresponding to the PRACH configuration index. The UE transmits the selected random access preamble in the selected subframe.

Upon receiving the random access preamble, the eNodeB sends a random access response (RAR) to the UE. The RAR is detected in two steps. First, the UE detects a PDCCH masked with a random access (RA)-RNTI. The UE receives an RAR in a MAC (medium access control) PDU (protocol data unit) on a PDSCH indicated by the detected PDCCH.

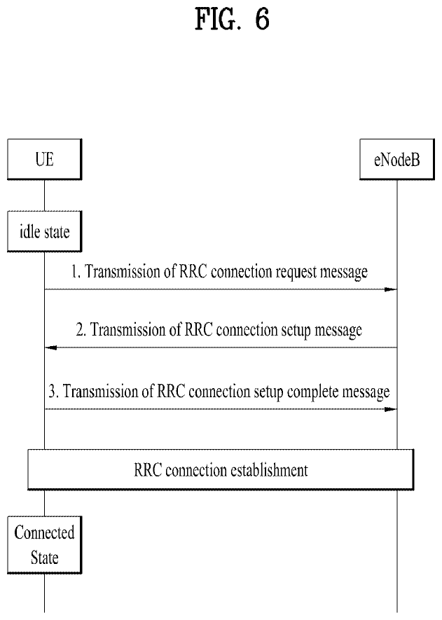

FIG. 6 illustrates a connection procedure in a radio resource control (RRC) layer.

As shown in FIG. 6, the RRC state is set according to whether or not RRC connection is established. An RRC state indicates whether or not an entity of the RRC layer of a UE has logical connection with an entity of the RRC layer of an eNodeB. An RRC state in which the entity of the RRC layer of the UE is logically connected with the entity of the RRC layer of the eNodeB is called an RRC connected state. An RRC state in which the entity of the RRC layer of the UE is not logically connected with the entity of the RRC layer of the eNodeB is called an RRC idle state.

A UE in the Connected state has RRC connection, and thus the E-UTRAN may recognize presence of the UE in a cell unit. Accordingly, the UE may be efficiently controlled. On the other hand, the E-UTRAN cannot recognize presence of a UE which is in the idle state. The UE in the idle state is managed by the core network in a tracking area unit which is an area unit larger than the cell. The tracking area is a unit of a set of cells. That is, for the UE which is in the idle state, only presence or absence of the UE is recognized in a larger area unit. In order for the UE in the idle state to be provided with a usual mobile communication service such as a voice service and a data service, the UE should transition to the connected state.

When the user initially turns on the UE, the UE searches for a proper cell first, and then stays in the idle state. Only when the UE staying in the idle state needs to establish RRC connection, the UE establishes RRC connection with the RRC layer of the eNodeB through the RRC connection procedure and then performs transition to the RRC connected state.

The UE staying in the idle state needs to establish RRC connection in many cases. For example, the cases may include an attempt of a user to make a phone call, an attempt to transmit data, or transmission of a response message after reception of a paging message from the E-UTRAN.

In order for the UE in the idle state to establish RRC connection with the eNodeB, the RRC connection procedure needs to be performed as described above. The RRC connection procedure is broadly divided into transmission of an RRC connection request message from the UE to the eNodeB, transmission of an RRC connection setup message from the eNodeB to the UE, and transmission of an RRC connection setup complete message from the UE to eNodeB, which are described in detail below with reference to FIG. 6.

1) When the UE in the idle state desires to establish RRC connection for reasons such as an attempt to make a call, a data transmission attempt, or a response of the eNodeB to paging, the UE transmits an RRC connection request message to the eNodeB first.

2) Upon receiving the RRC connection request message from the UE, the ENB accepts the RRC connection request of the UE when the radio resources are sufficient, and then transmits an RRC connection setup message, which is a response message, to the UE.

3) Upon receiving the RRC connection setup message, the UE transmits an RRC connection setup complete message to the eNodeB. Only when the UE successfully transmits the RRC connection setup message, does the UE establish RRC connection with the eNodeB and transition to the RRC connected mode.

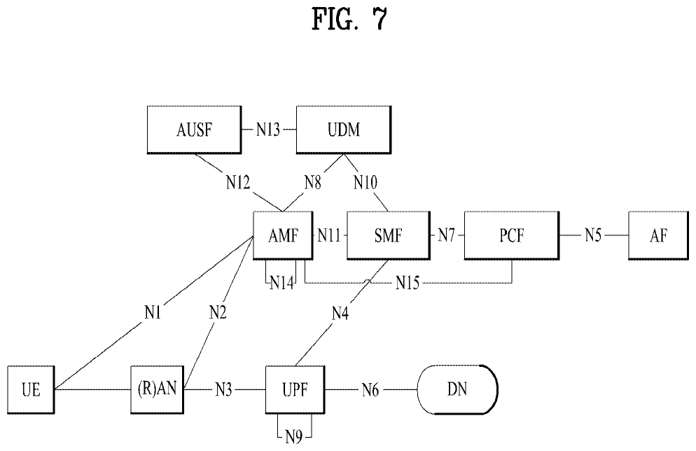

An MME in a legacy EPC has been divided into a core access and mobility management function (AMF) and a session management function (SMF) in a next generation system (or a 5G core network (CN)). Then, NAS interaction with the UE and mobility management (MM) are performed by the AMF, and session management (SM) is performed by the SMF. The SMF manages a user-plane function (UPF), which corresponds to a gateway managing a user plane, that is, a gateway for routing user traffic. That is, in the legacy EPC, the SMF may be regarded as being responsible for the control plane of an S-GW and a P-GW and the UPF may be regarded as being responsible for the user plane of the S-GW and the P-GW. For user traffic routing, one or more UPFs may be present between a RAN and a data network (DN). That is, the legacy EPC may be configured in the 5G system as illustrated in FIG. 7. As a concept corresponding to a PDN connection in the legacy EPS, a protocol data unit (PDU) session has been defined in the 5G system. The PDU session refers to association between the UE and the DN, which provides not only an IP type but also an Ethernet type or an unstructured type of PDU connectivity service. A unified data management (UDM) serves as an HSS of the EPC, and a policy control function (PCF) serves as a PCRF of the EPC. To satisfy requirements of the 5G system, these functions may be extended. Details of the 5G system architecture, individual functions, and individual interfaces comply with TS 23.501.

The 5G system is tasked with TS 23.501, TS 23.502, and TS 23.503. Accordingly, in the present disclosure, the 5G system complies with the above specifications. A detailed architecture and description related to a next generation (NG)-RAN comply with TS 38.300. The 5G system also supports non-3GPP access. An architecture for supporting non-3GPP access and a description of network elements are described in clause 4.2.8 of TS 23.501 and procedures for supporting non-3GPP access are described in clause 4.12 of TS 23.502. A representative example of non-3GPP access may be WLAN access which includes both a trusted WLAN and an untrusted WLAN. The AMF of the 5G system performs registration management (RM) and connection management (CM) for non-3GPP access as well as for 3GPP access.

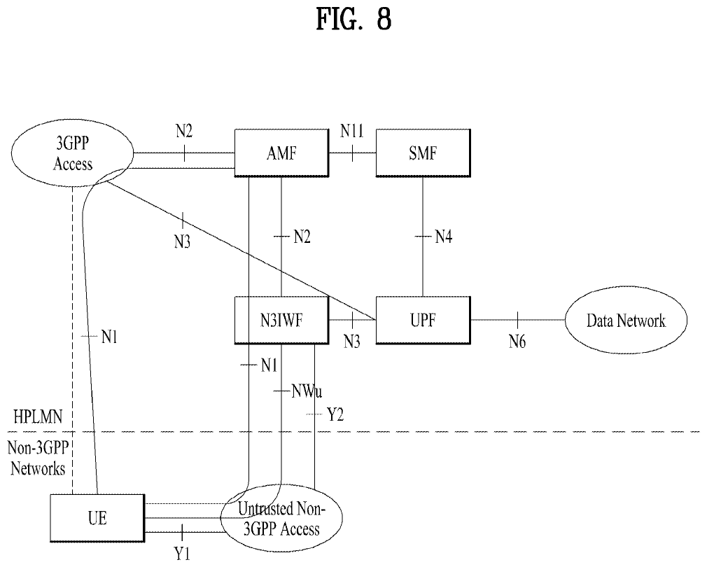

FIG. 8 illustrates a non-roaming architecture supporting non-3GPP access. As illustrated in FIG. 8, a UE is served by the same AMF for 3GPP access and non-3GPP access of the same PLMN, so that one network function may unitedly and efficiently support authentication, MM, SM, etc. for the UE registered via two different accesses.

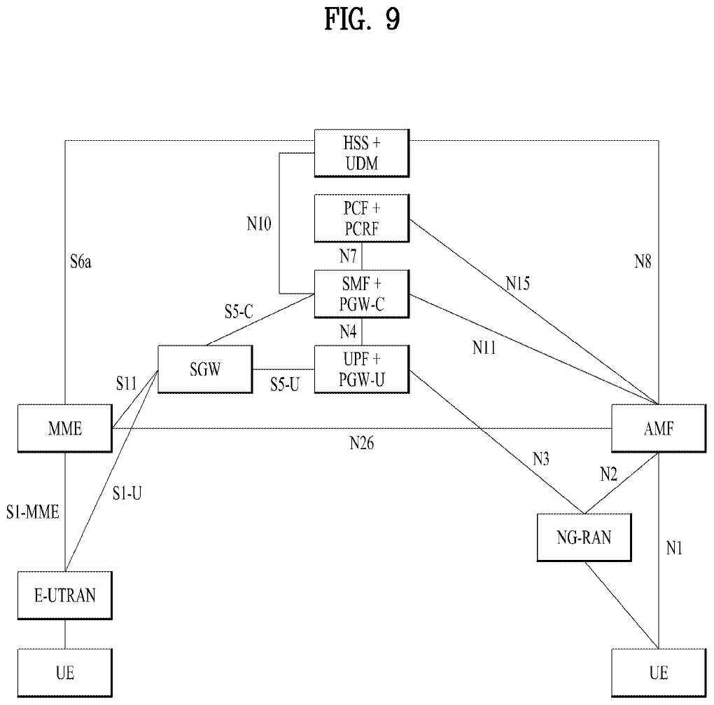

FIG. 9 illustrates an interworking architecture between a 5G system and an EPS when a UE does not roam. There is an interface between an MME and an AMF, i.e., N26, which is an interface between core networks. N26 may be supported or may not be supported according to selection of an operator. Clause 4.3 of TS 23.501v15.0.0 proposes in detail the interworking architecture between the 5G system and the EPS.

In regard to a short message service (SMS), SMS over NAS is a scheme of transmitting the SMS to a control plane. In contrast, there is a scheme of transmitting the SMS to the user plane using an IP multimedia subsystem (IMS). For the contents of SMS over NAS in a fifth-generation core network (5GC), reference is made to clause 4.4.2 (SMS over NAS) of TS 23.501v15.0.0 and clause 4.13.3 (SMS over NAS procedure) of TS 23.502v15.0.0. Particularly, the contents described in Registration procedures for SMS over NAS of clause 4.13.3.1 of TS 23.501v15.0.0 and the contents described in MT SMS over NAS in CM-IDLE state via 3GPP access of clause 4.13.3.1 of TS 23.501v15.0.0 will be integrated into the prior art of the present disclosure.

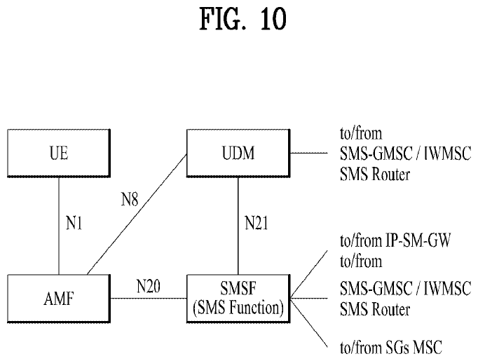

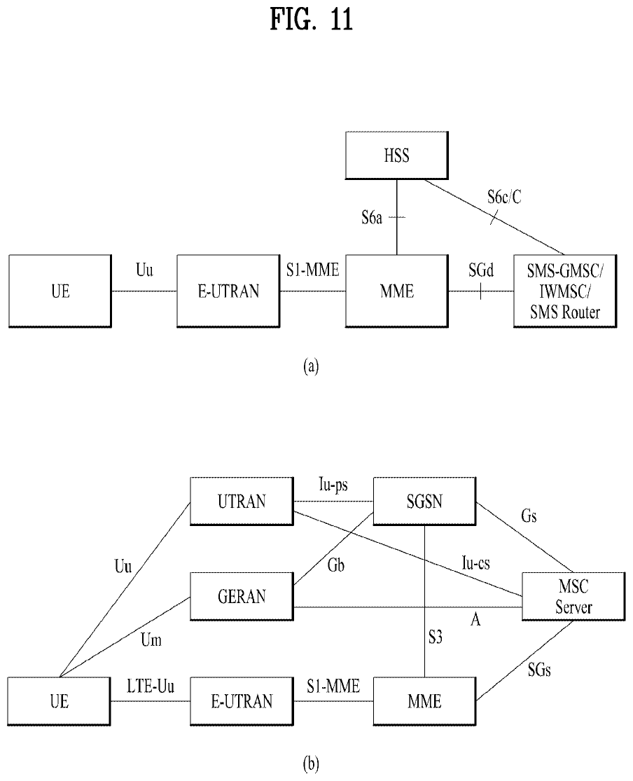

FIG. 10 illustrates a non-roaming system architecture for an SMS over NAS. The SMS over NAS in the EPC may be divided into the case in which the MME supports an SMS function and the case in which the MME does not support the SMS function. The case in which the MME supports the SMS functions is when the MME supports an SMS protocol stack and the SMS is transmitted according to an architecture as illustrated in FIG. 11(a). For details of SMS transmission, reference is made to Annex C (normative): SMS in MME of TS 23.272. The case in which the MME does not support the SMS function is when the SMS protocol stack is not present in the MME and the SMS is transmitted according to an architecture as illustrated in FIG. 11(b). In this case, an MSC server (abbreviated as an MSC) supports the SMS function and this is referred to as an SMS over SGs. For details of the SMS over SGs, reference is made to TS 23.272.

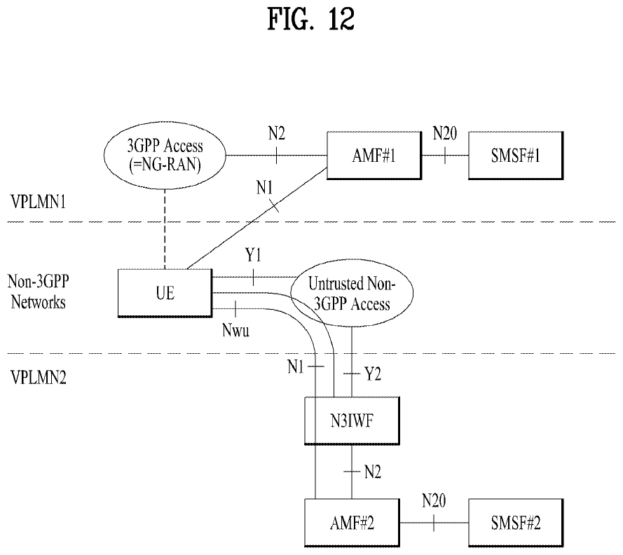

As specified in clause 4.13.3.9 (Unsuccessful mobile terminating SMS delivery attempt) of TS 23.502, if an attempt to deliver a mobile terminated (MT) SMS to a UE from an SMS function (SMSF) has failed, the SMSF may attempt to deliver the SMS to another entity (this means a serving node/entity of the UE for the SMS) when the SMSF supports an MT SMS domain selection function. In a fifth-generation system (5GS), the UE may be served through different PLMNs for 3GPP access and non-3GPP access. In this case, a serving SMSF as well as a serving AMF are present in each PLMN and two SMSFs are registered in a UDM. FIG. 12 illustrates such a situation. If the UE is registered in the 5GS only over one of 3GPP access and non-3GPP access and is registered in the same PLMN for both accesses, one serving AMF and one serving SMSF are present for the UE.

There may be the case in which the UE uses the SMS through an IMS. In this case, an Internet protocol short message gateway (IP-SM-GW) (also) becomes an SMS serving node of the UE. The UE may use the SMS through a non-IMS by being attached even to an EPS. In this case, when the MME supports the SMS, the MME (also) becomes the SMS serving node and, when the MME does not support the SMS, the MSC (also) becomes the SMS serving node of the UE. In this way, various types of serving nodes may be present for the SMS serving nodes of the UE. One SMSF or two SMSFs may be present. If an SMSF fails to deliver the MT SMS to the 5GS via the AMF, the SMSF may attempt to perform MT SMS delivery to another serving node. There are various scenarios in which the SMSF and another serving node are reachable or are not reachable (typically, the SMSF and another serving node may be regarded as being reachable when the SMSF and another serving node belong to the same PLMN).

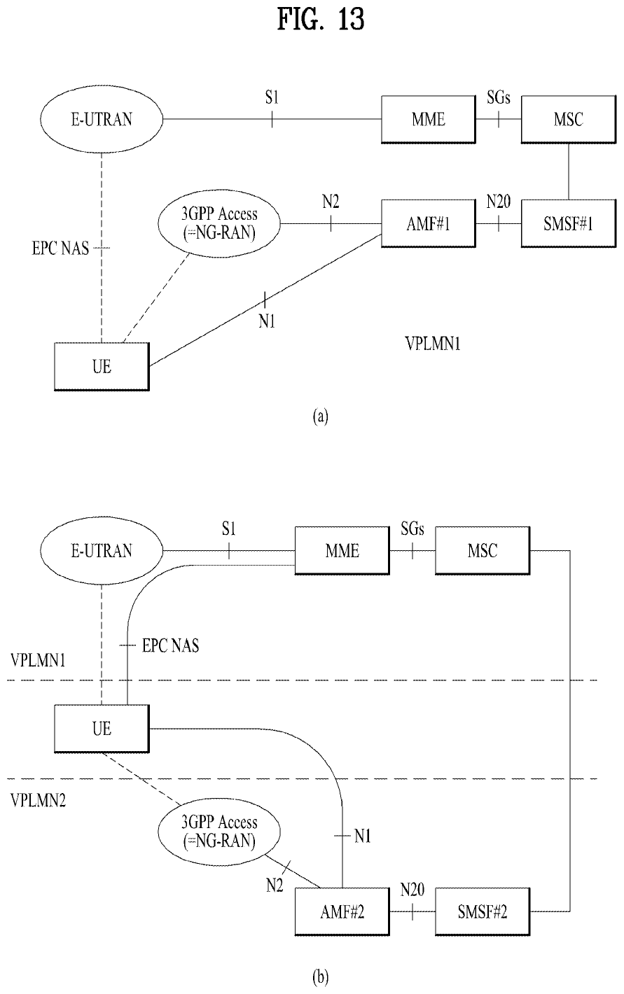

FIG. 13 illustrates the case in which a UE is attached to an EPC of VPLMN1 over 3GPP access (i.e., LTE) and is also registered in a 5GC of VPLMN1 over 3GPP access (e.g., NR). Since an MSC and SMSF#1, responsible for an SMS, belong to the same PLMN, the MSC and SMSF#1 may be regarded as being reachable via an interface. Next, the UE may exit from NR coverage of VPLMN1 to enter NR coverage of VPLMN2 and then may be registered in a 5GC of VPLMN2. Since the UE may not exit from LTE coverage of VPLMN1, the EPC remains attached to VPLMN1. This example is illustrated in FIG. 13(b). In this case, since the MSC and SMSF#2, responsible for the SMS, belong to different PLMNs, there is a high probability that the MSC and SMSF#2 are not reachable because there are no interfaces. However, interaction between an SMS-GMSC, a UDM, and an SMSF, particularly, an operation after the UDM receives a request message for routing information from the SMS-GMSC is unclear and there is no clear explanation about how the SMS-GMSC, the UDM, and the SMSF operate for various scenarios. Accordingly, various embodiments of how to process the SMS when an SMS serving node other than the SMSF is not reachable to the SMSF will be described hereinbelow. In the following description, the UDM may be the UDM plus an HSS for interworking with an EPS.

### Embodiment 1

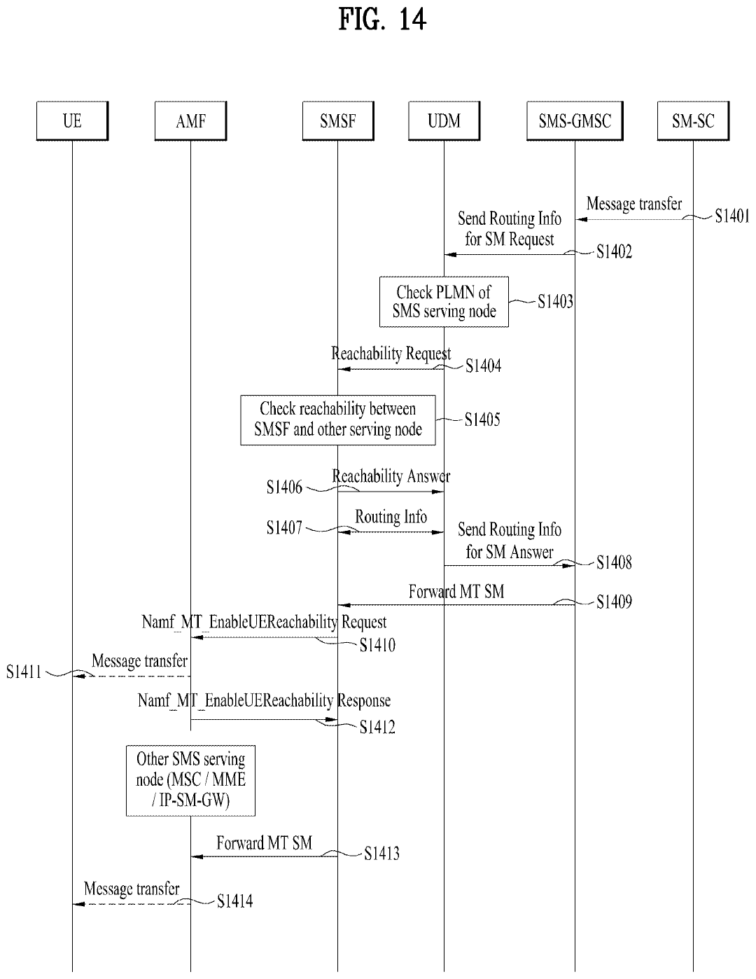

Hereinafter, an embodiment of the present disclosure will be described by focusing upon the UDM and then signaling/operation between nodes including the UDM will be described with reference to FIG. 14.

The UDM may receive a message for making a request to a UE for routing information about an SMS from an SMS-GMSC. The UDM may check whether a PLMN of an SMSF is identical to a PLMN of an SMS serving node. Here, the SMS serving node may be one of an MSC, an MME, and an IP-SM-GW. After checking whether the PLMNs are equal, the UDM may transmit, to the SMSF, a reachability check request message for an SMS serving node, a PLMN of which is not identical to the PLMN of the SMSF. In other words, when an SMS serving node other than the SMSF is present, the UDM first checks whether the PLMN of the SMS serving node is identical to the PLMN of the SMSF. If the PLMNs are identical, the SMS serving node and the SMSF may be regarded as having an interface therebetween. Accordingly, for an SMS serving node, a PLMN of which is not identical to the PLMN of the SMSF, the UDM checks whether there is reachability between the SMS serving node and the SMSF.

The UDM may receive a response to the reachability check request message from the SMSF and transmit routing information to the SMSF based on the check result and the response to the reachability check request message. Here, the routing information may include information about an SMS serving node which is reachable to the SMSF. The SMS serving node which is reachable to the SMSF is a target to which the SMS is to be delivered when the SMSF fails to deliver the SMS later. That is, the SMS serving node which is reachable to the SMSF may attempt to deliver the SMS when the SMSF fails to deliver the SMS. The information about the SMS serving node may be one of information about an address of the SMS serving node or information about a PLMN to which the SMS serving node belongs.

Next, the UDM may transmit a response message in response to the message for requesting the routing information to the SMS-GMSC. The response message in response to the request message for the routing information may include information about an SMS serving node that is not reachable to the SMSF. Thereafter, the SMS-GMSC attempts to deliver an MT SMS based on the routing information obtained from the UDM. If information about a plurality of serving nodes is obtained, the SMS-GMSC may sequentially attempt to deliver the MT SMS until SMS delivery is successful.

Hereafter, overall signaling and operation between network nodes according to a first embodiment of the present disclosure will be described with reference to FIG. 14.

A short message service center (SM-SC) (simply, a service center (SC)) transfers, to the SMS-GMSC, an SMS to be transferred to the UE (S1401). The SMS-GMSC sends a message for requesting routing information to the UDM in order to obtain the routing information about to which entity the SMS is to be sent (S1402).

In step S1403, the UDM checks whether there are SMS serving nodes other than an SMSF among SMS serving nodes registered with respect to the UE. If the SMS serving nodes other than the SMSF are present, the UDM checks whether a PLMN of the registered SMSF is identical to PLMNs of the serving nodes other than the SMSF. This may be interpreted as checking whether the SMSF and the serving nodes other than the SMSF belong to the same PLMN (or EPLMN). As a result of checking whether the PLMNs of the SMSF and the serving nodes other than the SMSF are identical, if at least one SMS serving node (i.e., node other than the SMSF) belonging to a PLMN which is not identical to the PLMN of the SMSF is present, the UDM transmits a request message for checking whether there is reachability (this may be interpreted as connectivity) between the serving node and the SMSF. If there are two SMSFs, it is checked whether a PLMN of each SMSF is identical to the PLMNs of the serving nodes other than the SMSF. As the checking result, if at least one SMS serving node (node other than the SMSF) belonging to a PLMN which is not identical to the PLMN of the SMSF is present, step S1404 is performed between each SMSF and the SMS serving node. Although step S1403 (and subsequent operations based on step S1403) may always be performed, step S1403 may be performed when one or more of the following conditions a) to e) is satisfied:

a) the case in which the UDM is aware that the SMSF supports an MT SMS domain selection function. This may be known when the SMSF informs the UDM that the SMSF supports the MT SMS domain selection function during registration or may be configured in the UDM.

b) the case in which the SMSF is configured to perform an MT SMS domain selection related operation according to local configuration of the UDM,

c) the case in which the SMSF is configured to perform the MT SMS domain selection related operation according to operator policy,

d) the case in which the SMSF is configured to perform the MT SMS domain selection related operation according to subscriber information, and

e) the case in which there is information indicating that SMSF based (or 5GS NAS based) SMS delivery is prioritized.

In step S1404, the UDM transmits, to the SMSF, a request message for checking whether there is reachability (this may be interpreted as connectivity) between the serving node and the SMSF, including information about an address of the SMS serving node belonging to a PLMN which is not identical to a PLMN of the SMSF. When two SMSFs are present, the UDM may transmit a request message to each of the two SMSFs.

In step S1405, the SMSF checks reachability between the SMSF and the SMS serving node. A specific example of determining that the SMSF and the SMS serving node are reachable is the case in which there is an interface configured therebetween when the serving node is installed in the SMSF in the SMSF. Alternatively, information about reachability between nodes may be prestored in the SMSF. As a specific example, the information about reachability may be prestored in units of nodes or in units of PLMNs to which nodes belong. These points are may be applied to determining whether there is reachability between the SMSF and other SMS serving nodes throughout the present disclosure.

In step S1406, the SMSF transfers, to the UDM, an answer as to whether serving nodes indicated by the UDM are reachable to the SMSF. This answer may be explicit or implicit. For example, whether the SMSF is reachable to each of the serving nodes indicated by the UDM may be marked or an answer including only reachable nodes may be transmitted. In contrast, an answer including only unreachable nodes may be transmitted. Alternatively, both a list of reachable nodes and a list of unreachable nodes may be provided. This is applied to the case in which the SMSF transfers an answer about whether there is reachability between the SMSF and other serving nodes to the UDM throughout the present disclosure.

In step S1407, the UDM which has determined a reachability relation between the SMSF and SMS serving node(s) other than the SMSF provides the SMSF with information about addresses of corresponding SMS serving nodes (this may be interpreted as routing information and may include information about PALMNs to which the serving nodes belong) when there are serving nodes that are reachable to the SMSF. The serving nodes other than the SMSF may be one or more of an MSC, an MME, and an IP-SM-GW. If there are two SMSFs and there are other serving nodes reachable to each SMSF, the above procedure is performed for each of the two SMSFs.

While the UDM forwards the message received from the SMS-GMSC in step S1402 (i.e., Send Routing Info for SM Request) to the SMSF, if there are other serving nodes, the UDM may forward the message including information about addresses of the corresponding serving nodes. Alternatively, the UDM may forward the message received from the SMS-GMSC in step S1402 to the SMSF and, if other serving nodes are present, the UDM may transmit information about addresses of the corresponding serving nodes to the SMSF through an additional message.

In step S1408, the UDM provides the SMS-GMSC with information about an address of the SMSF (this may be interpreted as routing information and may include information about a PLMN to which the SMSF belongs). There are SMS serving nodes other than the SMSF. If serving nodes which are not reachable to any SMSF are present, the UDM provides the SMS-GMSC with information about addresses of these serving nodes together with a message for routing information. The message transmitted by the UDM to the SMS-GMSC may be generated by the SMSF and the UDM may transmit the message to the SMS-GMSC. Step S1408 may be performed earlier than step S1407 or steps 1408 and 1407 may be simultaneously performed.

In step S1409, the SMS-GMSC attempts to forward an MT SMS based on the routing information obtained from the UDM. Upon obtaining information about a plurality of serving nodes, the SMS-GMSC may sequentially attempt to forward the MT SMS until MT SMS forwarding is successful. FIG. 14 illustrates an attempt to forward the MT SMS to the SMSF.

In step S1410 to step S1412, the SMSF attempts to forward the MT SMS via an AMF. In the present disclosure, the case of failure of forwarding will be described hereinbelow.

In step S1413, the SMSF attempts to forward the MT SMS to the other serving nodes based on information about the other reachable serving nodes, obtained in step S1407. When there are multiple other reachable serving nodes, the SMSF may sequentially attempt to forward the MT SMS until MT SMS forwarding is successful. If all forwarding attempts fail, the SMSF informs the SMS-GMSC of forwarding failure. When there are no other reachable serving nodes, if the SMSF fails to forward the MT SMS, the SMSF immediately informs the SMS-GMSC of forwarding failure.

In step S1414, the serving node that has received a request for MT SMS forwarding from the SMSF attempts to forward the MT SMS to the UE. A subsequent operation, i.e., an operation of informing the SMSF of MT SMS forwarding success or failure, may conform to a conventional operation.

As described above, the SMSF attempts to forward the MT SMS to reachable serving nodes (when present) until MT SMS forwarding is successful. The SMS-GMSC also attempts to forward the MT SMS to the reachable serving nodes until MT SMS forwarding is successful. This is applied to overall operation of the present disclosure.

### Embodiment 2

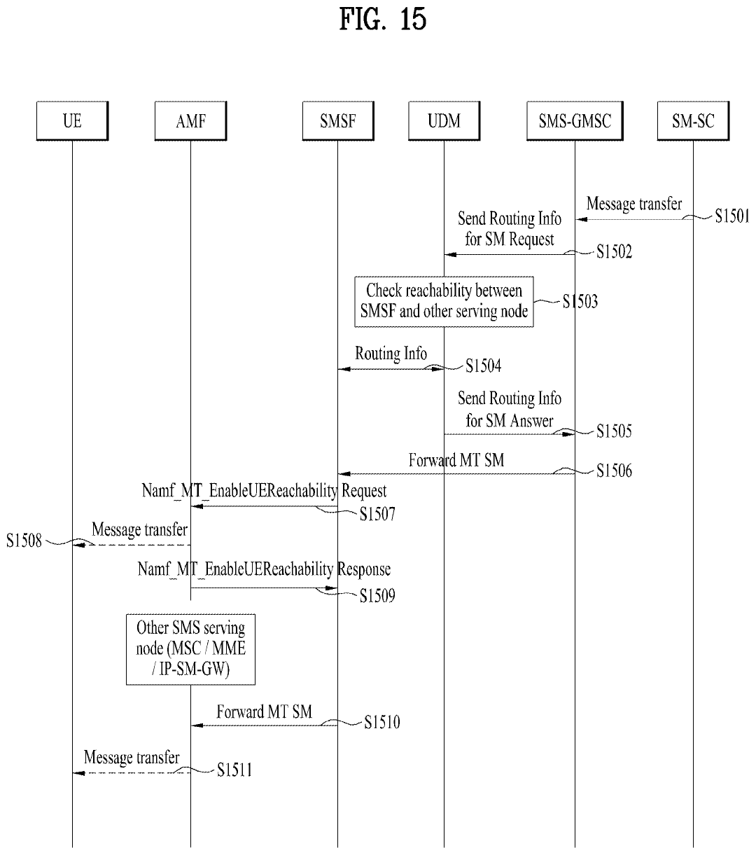

Embodiment 2 will now be described with reference to FIG. 15.

Steps S1501 and S1502 are equal to steps 1401 and 1402 of Embodiment 1.

In step S1503, the UDM checks whether there are serving nodes other than an SMSF among SMS serving nodes registered with respect to the UE. If the serving nodes other than the SMSF are present, the UDM checks reachability (this may be interpreted as connectivity) between the registered SMSF and the serving nodes other than the SMSF. If two SMSFs are present, the UDM checks reachability between each of the two SMSFs and the serving nodes other than the SMSFs. As a representative condition for determining that nodes are reachable, if two nodes belong to the same PLMN (or EPLMN), it may be determined that the two nodes are reachable. In addition to the above condition, information about reachability between nodes may be prestored in the UDM in units of nodes or in units of PLMNs to which nodes belong. These points may be applied to the case in which the UDM checks reachability between the SMSF and SMS serving nodes other than the SMSF throughout the present disclosure.

In step S1504, when there are serving nodes that are reachable to the SMSF, the UDM provides the SMSF with information about addresses of the corresponding serving nodes (this information may be interpreted as routing information and may include information about PLMNs to which the serving nodes belong). The serving nodes that are reachable to the SMSF may be one or more of an MSC, an MME, and an IP-SM-GW. When there are two SMSFs and there are other serving nodes that are reachable to each SMSF, step S1504 is performed with respect to each of the two SMSFs.

While the UDM forwards the message received from the SMS-GMSC in step S1502 (i.e., Send Routing Info for SM Request) to the SMSF, if there are other serving nodes, the UDM may forward the message including information about addresses of the corresponding serving nodes. Alternatively, the UDM may forward the message received from the SMS-GMSC in step S1502 to the SMSF and, if other serving nodes are present, the UDM may transmit information about addresses of the corresponding serving nodes to the SMSF through an additional message.

In step S1505, the UDM provides the SMC-GMSC with information about an address of the SMSF (this information may be interpreted as routing information and may include information about a PLMN to which the SMSF belongs). There are SMS serving nodes other than the SMSF. If serving nodes that are not reachable to any SMSF are present, the UDM provides the SMS-GMSC with information about addresses of the corresponding serving nodes together with a message for routing information. The message transmitted by the UDM to the SMS-GMSC may be generated by the SMSF and the UDM may transmit the message to the SMS-GMSC. Step S1505 may be performed earlier than step S1504 or Steps S1505 and S1504 may be simultaneously performed.

In step S1506, the SMS-GMSC attempts to forward an MT SMS based on the routing information obtained from the UDM. Upon obtaining information about a plurality of serving nodes, the SMS-GMSC may sequentially attempt to forward the MT SMS until MT SMS forwarding is successful. FIG. 15 illustrates an attempt to forward the MT SMS to the SMSF.

In step S1507 to step S1509, the SMSF attempts to transmit the MT SMS through the AMF. However, it is assumed that the SMSF fails to transmit the MT SMS.

In step S1510, the SMSF attempts to forward the MT SMS to the other serving nodes based on information about the other reachable serving nodes, obtained in step S1504. When there are multiple other reachable serving nodes, the SMSF may sequentially attempt to forward the MT SMS until MT SMS forwarding is successful. If all forwarding attempts fail, the SMSF informs the SMS-GMSC of forwarding failure. When there are no other reachable serving nodes, if the SMSF fails to forward the MT SMS, the SMSF immediately informs the SMS-GMSC of forwarding failure.

In step S1511, the serving node that has received a request for MT SMS forwarding from the SMSF attempts to forward the MT SMS to the UE. A subsequent operation, i.e., an operation of informing the SMSF of forwarding success or failure, may conform to a conventional operation.

As described above, the SMSF attempts to forward the MT SMS to reachable serving nodes (when present) until MT SMS forwarding is successful. The SMS-GMSC also attempts to forward the MT SMS to the reachable serving nodes until MT SMS forwarding is successful. This is applied to overall operation of the present disclosure.

In message exchange between the SMS-GMSC and the UDM and between the UDM and the SMSF described in steps S1502, S1504, and S1505, the UDM may serve to transfer a message in the middle of nodes and provide the SMSF with information about a serving node other than the SMSF and the SMS-GMSC with information about a serving node that is not reachable to the SMSF. A reception node of a message that has actually been transmitted by the SMS-GMSC in order to request routing information may be the SMSF. Conversely, a reception node of a response message of the routing information provided by the SMSF may be the SMS-GMSC. This may be applied to overall operation of the present disclosure.

### Embodiment 3

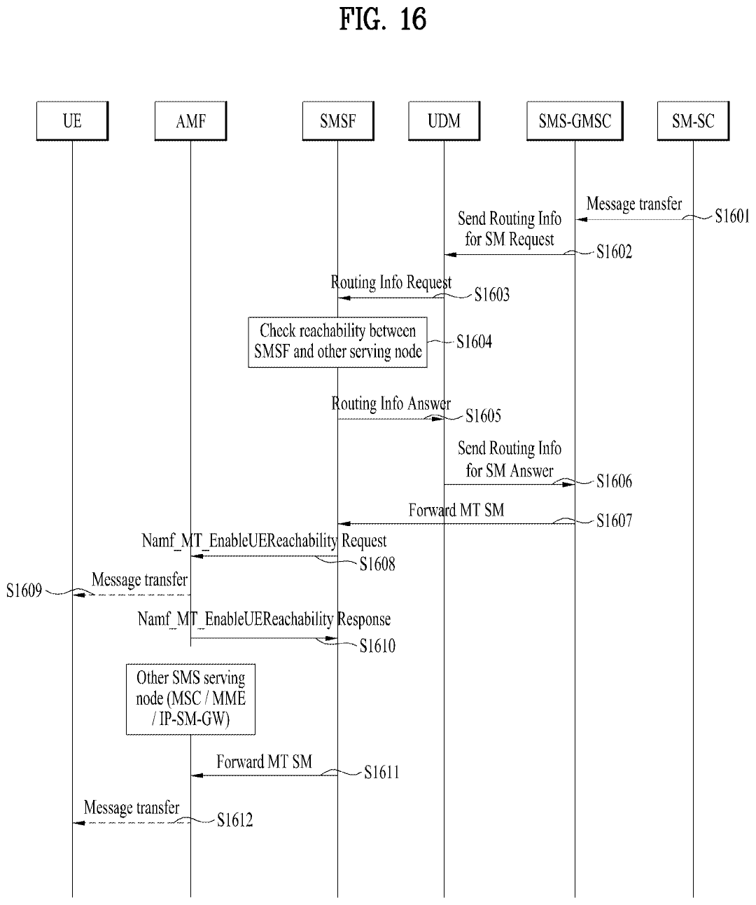

Embodiment 3 will now be described with reference to FIG. 16.

Steps S1601 and S1602 are equal to steps S1401 and S1402 of Embodiment 1.

In step S1603, the UDM checks whether there are serving nodes other than an SMSF among SMS serving nodes registered with respect to the UE. If the serving nodes other than the SMSF are present, the UDM transmits a request message for checking whether there is reachability (this may be interpreted as connectivity) between the registered SMSF and these serving nodes to the registered SMSF. The request message includes information about addresses of the serving nodes other than the SMSF. If two SMSFs are present, the UDM may transmit the request message to each of the two SMSFs. Although step S1603 (and subsequent operations based on step S1603) may always be performed, step S1603 may be performed when one or more of the conditions a) to e) described in step S1403 of Embodiment 1 is satisfied.

In step S1604, the SMSF checks reachability between the SMSF and the serving nodes. A specific condition of determining that two nodes are reachable is when the two nodes belong to the same PLMN (or EPLMN). In addition to the above example, it may be determined that the SMSF and the serving nodes are reachable in the case in which there is an interface configured therebetween when the serving node is installed in the SMSF. Alternatively, information about reachability between nodes may be prestored in the SMSF in units of nodes or in units of PLMNs to which nodes belong. These points may be applied to the case in which the SMSF determines whether there is reachability between the SMSF and other SMS serving nodes throughout the present disclosure.

In step S1605, the SMSF transmits, to the UDM, an answer as to whether serving nodes indicated by the UDM are reachable to the SMSF. This answer may be explicit or implicit. For example, whether the SMSF is reachable to each of the serving nodes indicated by the UDM may be marked or an answer including only reachable nodes may be transmitted. In contrast, an answer including only unreachable nodes may be transmitted. Alternatively, both a list of reachable nodes and a list of unreachable nodes may be provided. This is applied to the case in which the SMSF transmits an answer about whether there is reachability between the SMSF and other serving nodes to the UDM throughout the present disclosure.

In step S1606, the UDM transmits information about an address of the SMSF to the SMS-GMSC. There are SMS serving nodes other than the SMSF. If serving nodes that are not reachable to any SMSF is present, the UDM also provides information about addresses of the corresponding serving nodes to the SMS-GMSC.

Steps S1607 to S1612 are equal to steps S1506 to 1511 of Embodiment 2.

### Embodiment 4

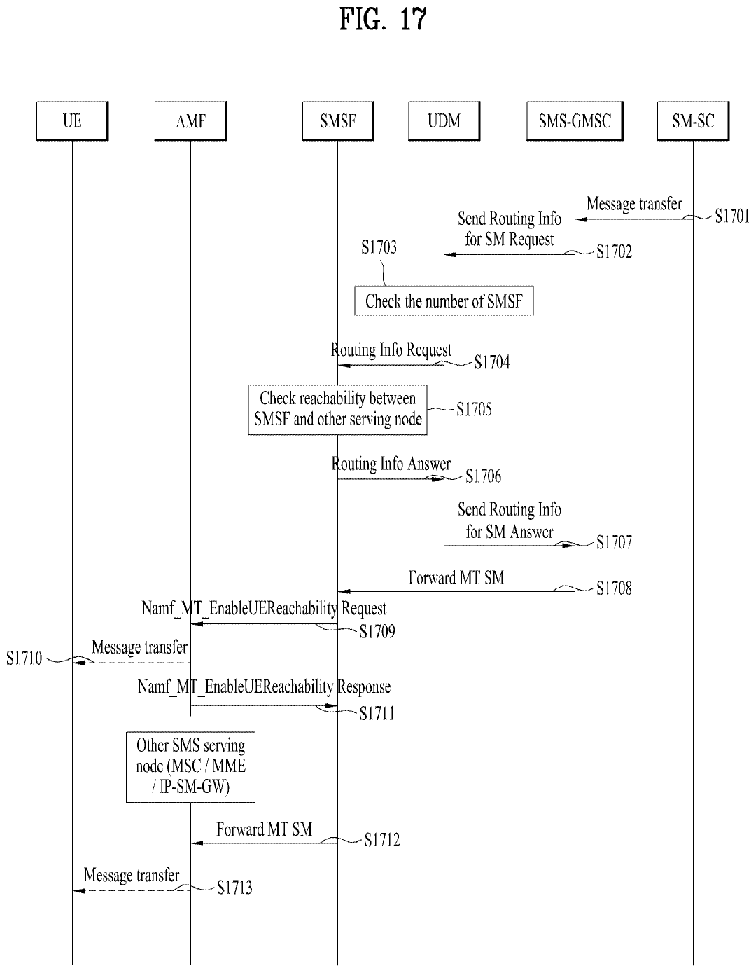

Embodiment 4 will now be described with reference to FIG. 17.

Steps S1701 and S1702 are equal to steps S1401 and S1402 of Embodiment 1.

In step S1703, the UDM checks the number of SMSFs registered with respect to the UE. If the number of SMSFs registered with respect to the UE is 1 and there are SMS serving nodes other than the SMSF, subsequent steps are performed. Although step S1703 (and subsequent operations based on step S1703) may always be performed, step S1703 may be performed when one or more of the conditions a) to e) described in step S1403 of Embodiment 1 is satisfied.

In step S1704, the UDM transmits a request message for checking whether there is reachability (this may be interpreted as connectivity) between the SMSF and other serving nodes to the SMSF. The request message includes information about addresses of the serving nodes other than the SMSF.

In step S1705, the SMSF checks reachability between the SMSF and the serving nodes.

In step S1706, the SMSF transfer an answer as to whether serving nodes indicated by the UDM is reachable to the SMSF to the UDM.

In step S1707, the UDM provides information about an address of the SMSF to the SMS-GMSC. There are SMS serving nodes other than the SMSF. If serving nodes that are not reachable to the SMSF are present, the UDM also provides information about addresses of theses serving nodes to the SMS-GMSC.

Steps S1708 to S1713 are equal to steps 1506 to 1511 of Embodiment 2.

In the above description, the SMSF has checked whether the SMSF is reachable to other serving nodes. Unlike this example, after S1703, the UDM may check whether the SMSF is reachable to other serving nodes so that information about addresses of the serving nodes that are reachable to the SMSF may be provided to the SMSF and the information about the addresses of the serving nodes that are reachable to the SMSF and information about an address of the SMSF may be provided to the SMS-GMSC. In this case, whether the number of SMFS is 1 as described in step S1703 may not be checked.

### Embodiment 5

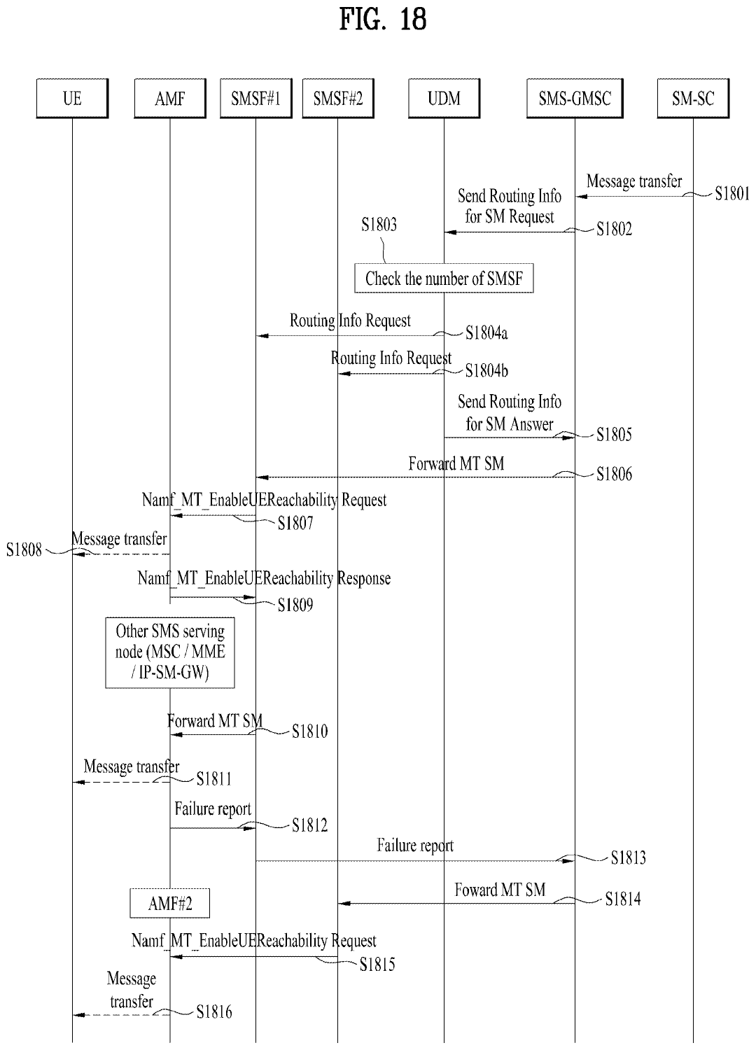

Embodiment 5 will now be described with reference to FIG. 18.

Steps S1801 and S1802 are equal to steps S1401 and S1402 of Embodiment 1.

In step S1803, the UDM checks the number of SMSFs registered with respect to the UE. If the number of SMFSs registered with respect to the UE is 2 and there are SMS serving nodes other than the SMSFs, subsequent steps are performed. The reason why the number of SMSFs is two is that the UE is registered in different PLMNs over 3GPP access and non-3GPP access (or selected non-3GPP interworking function (N3IWF)). Each serving AMF is present in each PLMN and each SMSF in which the AMF is activated is also present in each PLMN. Although S1803 (and subsequent operations based on step S1803) may always be performed, step S1803 may be performed when one or more of the conditions a) to e) described in step S1403 of Embodiment 1 is satisfied.

In steps S1804a and S1804b, the UDM provides information about addresses of serving nodes other than the SMSFs to each SMSF.

In step S1805, the UDM provides information about addresses of the two SMSFs to the SMS-GMSC.

Step S1805 may be performed earlier than steps S1804a and S1804b or steps S1805 and S1804a and S1804b may be simultaneously performed.

In step S1806, the SMS-GMSC attempts to forward an MT SMS based on the routing information obtained from the UDM. Since the SMS-GMSC has obtained the information about the addresses of the two SMSFs, the SMS-GMSC may sequentially attempt to forward the MT SMS until MT SMS forwarding is successful. FIG. 18 illustrates that the SMS-GMSC attempts to forward the MT SMS first to SMSF#1.

In steps S1807 to S1809, SMSF#1 attempts to forward the MT SMS through AMF#1. However, it is assumed that SMSF#1 fails to forward the MT SMS.

In step S1810, SMSF#1 attempts to forward the MT SMS to a reachable serving node based on the information about the other serving nodes, obtained in step S1804a. When there are multiple other reachable serving nodes, SMSF#1 may sequentially attempt to forward the MT SMS until MT SMS forwarding is successful. If all forwarding attempts fail, SMSF#1 informs the SMS-GMSC of forwarding failure. When there are no other reachable serving nodes, if SMSF#1 fails to forward the MT SMS, SMSF#1 immediately informs the SMS-GMSC of forwarding failure.

In step S1811, a serving node that has received a request for MT SMS forwarding from the SMSF attempts to forward the MT SMS to the UE. A subsequent operation, i.e., an operation of informing the SMSF of forwarding success or failure, may conform to a conventional operation.

In steps S1812 and S1813 of FIG. 18, it is assumed that all of MT SMS forwarding attempted by SMSF#1 fails. SMSF#1 informs the SMS-GMSC of forwarding failure.

In step S1814, the SMS-GMSC attempts to forward the MT SMS to SMSF#2.

In steps S1815 and S1816, SMSF#2 attempts to forward the MT SMS through AMF#2. If SMSF#2 fails to forward the MT SMS, SMSF#2 attempts to forward the MT SMS to a reachable serving node based on the information about the other serving nodes, obtained in step S1804b. When there are multiple other reachable serving nodes, SMSF#2 may sequentially attempt to forward the MT SMS until MT SMS forwarding is successful. If all transmission attempts fail, SMSF#2 informs the SMS-GMSC of forwarding failure. When there are no other reachable serving nodes, if SMSF#2 fails to forward the MT SMS, SMSF#2 immediately informs the SMS-GMSC of forwarding failure.

In the above description, the UDM has provided information about addresses of serving nodes other than SMSFs to each SMSF. Then, if the SMSF attempts to forward the MT SMS through the AMF and fails to forward the MT SMS, the SMSF attempts to forward serving nodes that are reachable to the SMSF. Unlike this example, when the UDM provides the addresses of the serving nodes other than SMSFs to each SMSF, the UDM may provide information about addresses of only serving nodes that are reachable to the corresponding SMSF.

### Embodiment 6

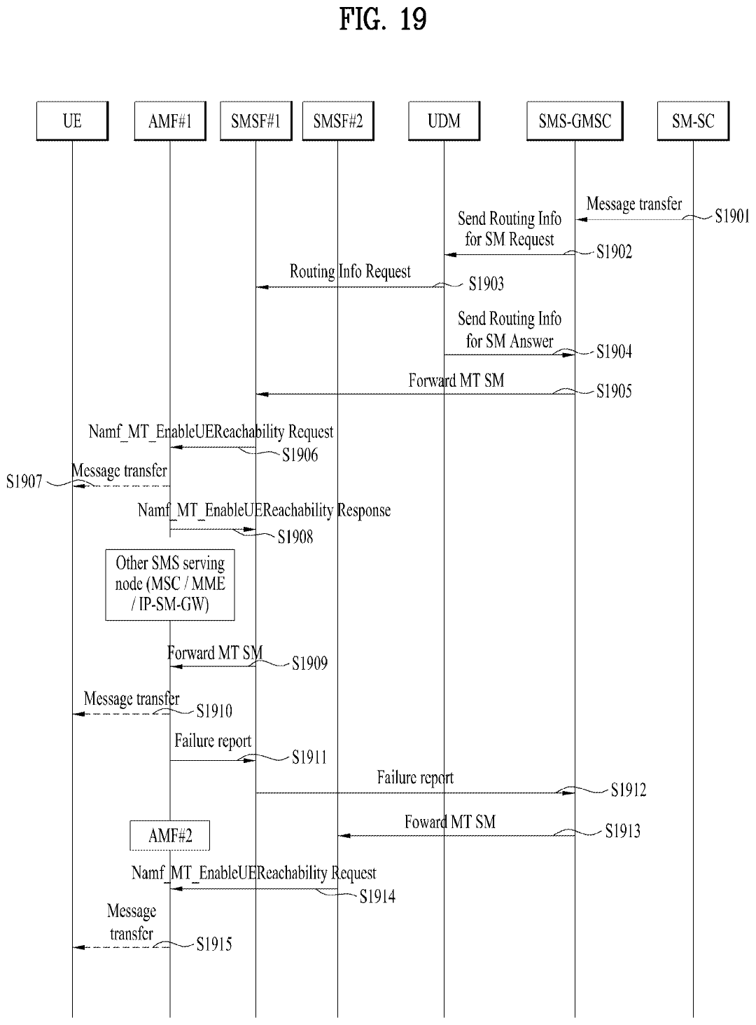

Embodiment 6 will now be described with reference to FIG. 19.

Steps S1901 and S1902 are equal to steps S1401 and S1402 of Embodiment 1.

In step S1903, the UDM may determine/consider that an SMSF registered with respect to the UE and SMS serving nodes other than the SMSF are reachable. That is, it may be considered that there is a connection between the SMSF and the SMS serving nodes during installation (the SMSF and the SMS serving node may be directly connected through an interface or through an entity such as an SMS router) or that the SMSF and the SMS serving nodes are reachable based on information configured in the UDM. This may be applied regardless of whether the SMSF and the other serving nodes belong to the same PLMN (or EPLMN) or not.

When there is one SMSF with respect to the UE, information about addresses of serving nodes other than the SMSF is provided to the SMSF. When there are two SMSFs with respect to the UE, one SMSF is selected and the information about the addresses of the serving nodes other than the SMSFs is provided only to the selected SMSF. As a criterion for selecting the one SMSF, whether the SMSF and the other serving nodes belong to the same PLMN (or EPLMN) or which access type (3GPP access or non-3GPP access) the SMSF serves may be considered. In FIG. 19, it is assumed that two SMSFs are present and, in particular, it is assumed that SMSF#1 is selected. Then, the UDM provides information about the addresses of the other serving nodes to SMSF#1. Although step S1903 (and subsequent operations based on step S1903) may always be performed, step S1903 may be performed when one or more of the conditions a) to e) described in step S1403 of Embodiment 1 is satisfied.

In step S1904, the UDM provides information about an address of the SMSF to the SMS-GMSC. When there are two SMSFs, the UDM provides information about addresses of the two SMSFs. Step S1903 may be performed earlier than step S1904 or Steps S1903 and S1904 may be simultaneously performed.

In step S1905, the SMS-GMSC attempts to forward an MT SMS based on the routing information obtained from the UDM. If the SMS-GMSC obtains the information about the addresses of the two SMSFs, the SMS-GMSC may sequentially attempt to forward the MT SMS until MT SMS forwarding is successful. FIG. 19 illustrates that the SMS-GMSC attempts to forward the MT SMS first to SMSF#1.

In steps S1906 to S1908, SMSF#1 attempts to forward the MT SMS through AMF#1. However, it is assumed that SMSF#1 fails to forward the MT SMS.

In step S1909, SMSF#1 attempts to forward the MT SMS to a reachable serving node based on the information about the other serving nodes, obtained in step S1903. When there are multiple other reachable serving nodes, SMSF#1 may sequentially attempt to forward the MT SMS until MT SMS forwarding is successful. If all forwarding attempts fail, SMSF#1 informs the SMS-GMSC of forwarding failure. When there are no other reachable serving nodes, if SMSF#1 fails to forward the MT SMS, SMSF#1 immediately informs the SMS-GMSC of forwarding failure.

In step S1910, the serving node that has received a request for MT SMS forwarding from the SMSF attempts to forward the MT SMS to the UE. A subsequent operation, i.e., an operation of informing the SMSF of forwarding success or failure, may conform to a conventional operation.

In steps S1911 and S1912, it is assumed that all MT SMS forwarding attempted by SMSF#1 fails. SMSF#1 informs the SMS-GMSC of forwarding failure.

In step S1913, the SMS-GMSC attempts to forward the MT SMS to SMSF#2.

In steps S1914 and S1915, SMSF#2 attempts to forward the MT SMS through AMF#2. If SMSF#2 fails to forward the MT SMS, SMSF#2 informs the SMS-GMSC of forwarding failure.

In the above description, the UDM has provided the information about the addresses of the serving nodes other than the SMSFs only to one SMSF when there are two SMSFs. Unlike this example, while the UDM provides the information about the addresses of the serving nodes other than the SMSFs to the two SMSFs, a higher priority may be given to one SMSF. Additionally, information indicating that there is another SMSF may be explicitly or implicitly provided to each SMSF. Then, each SMSF may determine whether to perform MT SMS domain selection (i.e., forwarding attempt during failure of SMS forwarding through an AMF) based on information about a priority assigned by the UDM, information as to whether there is another SMSF, information about a serving access type of an SMSF, and information about PLMNs of the serving nodes other than the SMSF.

Overview of a device to which the present disclosure is applicable

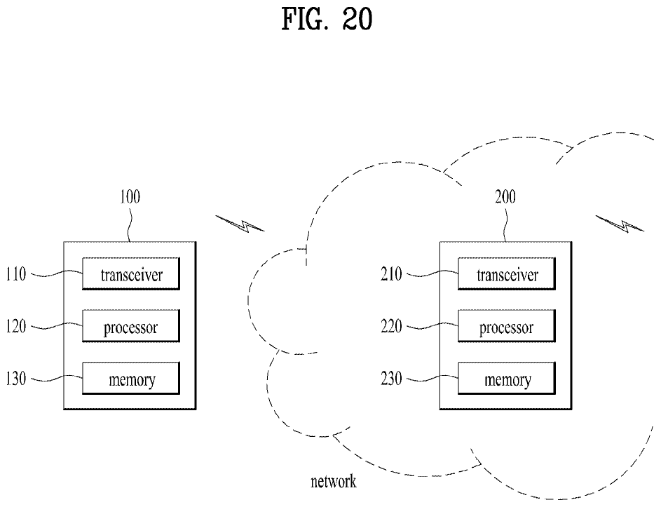

FIG. 20 is a diagram illustrating a configuration of an exemplary embodiment of a UE and a network node according to the present disclosure.

Referring to FIG. 20, a network node 200 according to the present disclosure may include a transceiver 210, and a device 220 for a wireless communication system. The device 220 for the wireless communication system may include a memory and at least one processor coupled to the memory. The transceiver 210 may be configured to transmit and receive various signals, data, and information to and from an external device. The network node 200 may be connected to the external device by wire and/or wirelessly. The at least one processor may control overall operation of the network node 200 and may be configured to cause the network node 200 to calculate and process information to be transmitted and received to and from the external device. The memory may store the calculated and processed information for a predetermined time and may be replaced with a constituent such as a buffer (not shown). The processor may also be configured to perform the operations of the network node proposed in the present disclosure.

Specifically, the at least one processor may receive, from an SMS-GMSC, a message for transmitting a request for routing information about an SMS to a UE, check whether a PLMN of an SMSF is equal to a PLMN of an SMS serving node, transmit a reachability check request message for an SMS serving node, the PLMN of which is not equal to the PLMN of the SMSF, to the SMSF, receive a response to the reachability check request message from the SMSF, transmit routing information to the SMSF based on the check result and the response to the reachability check request message, and transmit a response message for the message for the request for the routing information.

Referring to FIG. 20, a UE 100 according to the present disclosure may include a transceiver 110, and a device 120 for a wireless communication system. The device 120 for the wireless communication system may include a memory and at least one processor coupled to the memory. The transceiver 110 may be configured to transmit and receive various signals, data, and information to and from an external device. The UE 100 may be connected to the external device by wire and/or wirelessly. The at least one processor may control overall operation of the UE 100 and may be configured to cause the UE to calculate and process information to be transmitted and received to and from the external device. The memory may store the calculated and processed information for a predetermined time and may be replaced with a constituent such as a buffer (not shown). The processor may also be configured to perform the operations of the UE proposed in the present disclosure.

Regarding the configurations of the UE device 100 and the network device 200, the above-described various embodiments of the present disclosure may be applied independently, or two or more embodiments of the present disclosure may be applied at the same time. Redundant description has been omitted for clarity.

The embodiments of the present disclosure may be implemented through various means, for example, hardware, firmware, software, or a combination thereof.

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means.

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure. For example, those skilled in the art may use the components described in the foregoing embodiments in combination. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

While various embodiments of the present disclosure have been described in the context of a 3GPP system, the embodiments are applicable in the same manner to various mobile communication systems.

1. A method of transmitting and receiving a short message service (SMS)-related signal of a unified data management (UDM) in a wireless communication system, the method comprising:
receiving, by the UDM, a message for making a request to a user equipment (UE) for routing information about the SMS from an SMS-gateway mobile switching center (GMSC);
checking whether a public land mobile network (PLMN) of an SMS function (SMSF) is identical to a PLMN of an SMS serving node;
transmitting, by the UDM, a reachability check request message for an SMS serving node, a PLMN of which is not identical to the PLMN of the SMSF, to the SMSF;
receiving, by the UDM, a response to the reachability check request message from the SMSF;
transmitting, by the UDM, routing information to the SMSF based on the check result and the response to the reachability check request message; and
transmitting, by the UDM, a response message for the message for requesting the routing information to the SMS-GMSC.

2. The method of claim 1,
wherein the response message for the message for requesting the routing information includes information about an SMS serving node which is not reachable to the SMSF.

3. The method of claim 2,
wherein the SMS serving node is not reachable to the SMSF in absence of an interface between the SMS serving node and the SMSF.

4. The method of claim 1,
wherein the routing information includes information about an SMS serving node which is reachable to the SMSF.

5. The method of claim 1,
wherein an SMS serving node which is reachable to the SMSF attempts to transmit the SMS upon transmission failure of the SMS by the SMSF.

6. The method of claim 1,
wherein the SMS serving node is one of a mobile switching center (MSC), a mobility management entity (MME), and an IP short-messaging gateway (IP-SM-GW).

7. The method of claim 2,
wherein the information about the SMS serving node is one of information about an address of the SMS serving node or information about a PLMN to which the SMS serving node belongs.

8. A unified data management (UDM) device for transmitting and receiving a short message service (SMS)-related signal in a wireless communication system, the UDM device comprising:
a memory; and
at least one processor coupled to the memory,
wherein the at least one processor is configured to receive a message for making a request to a user equipment (UE) for routing information about the SMS from an SMS-gateway mobile switching center (GMSC), check whether a public land mobile network (PLMN) of an SMS function (SMSF) is identical to a PLMN of an SMS serving node, transmit a reachability check request message for an SMS serving node, a PLMN of which is not identical to the PLMN of the SMSF, to the SMSF, receive a response to the reachability check request message from the SMSF, transmit routing information to the SMSF based on the check result and the response to the reachability check request message, and transmit a response message for the message for requesting the routing information to the SMS-GMSC.

9. The UDM device of claim 8,
wherein the response message for the message for requesting the routing information includes information about an SMS serving node which is not reachable to the SMSF.

10. The UDM device of claim 9,
wherein the SMS serving node is not reachable to the SMSF in absence of an interface between the SMS serving node and the SMSF.

11. The UDM device of claim 8,
wherein the routing information includes information about an SMS serving node which is reachable to the SMSF.

12. The UDM device of claim 8,
wherein an SMS serving node which is reachable to the SMSF attempts to transmit the SMS upon transmission failure of the SMS by the SMSF.

13. The UDM device of claim 8,
wherein the SMS serving node is one of a mobile switching center (MSC), a mobility management entity (MME), and an IP short-messaging gateway (IP-SM-GW).

14. The UDM device of claim 9,
wherein the information about the SMS serving node is one of information about an address of the SMS serving node or information about a PLMN to which the SMS serving node belongs.
